(19) United States
(12) Patent Application Publication
(10) Pub. No.: US 2008/0147458 A1
(43) Pub. Date: Jun. 19, 2008

(54) BREEDING SUPPORT SYSTEM

(75) Inventors: Akihiro Yamazaki, Kanagawa (JP); Shuzo Gotoh, Kanagawa (JP); Kenji Nishii, Tiba (JP); Takahiro Kusano, Kanagawa (JP); Hirokazu Hayashi, Tokyo (JP); Kouichi Suzuki, Gumma (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/874,363

(22) Filed: Oct. 18, 2007

(30) Foreign Application Priority Data
Dec. 14, 2006 (JP) 2006337063

(51) Int. Cl. G06F 19/00

(52) U.S. Cl. 705/7

(57) ABSTRACT

A breeding support system including at least one information terminal for processing breeding information associated with breeding work of at least one individual breeding object, the system comprising: individual information collecting means for collecting individual information indicating a time-variable change of an individual condition of the individual breeding object; specified breeding work requirement determination means for determining a requirement for a specified breeding work from among all breeding work in accordance with a profile of the time-variable change of the individual condition; breeding guidance generation means for generating at least one breeding guidance announcing a requirement of the specified breeding work determined; and breeding guidance supply means for supplying the generated breeding guidance as the breeding information to the information terminal.

### BACKGROUND OF THE INVENTION

1. Field of the Invention

The present invention relates to a system for supporting animal breeding by processing breeding information of individual animals including farm animals such as dairy cows bred by dairy farmers and pet animals kept at home.

2. Description of the Related Art

Inbreeding of dairy cows, which is representative of breeding industries, about 20 liter of milk can be usually extracted per day per cow. Since a dairy cow produces milk for a period of about 300 days after giving birth (parturition), repeated parturitions due to artificial insemination every year allows substantially continuous production of milk although there may be a nonlactating period for resting the dairy cow. Artificial insemination is usually carried out after about 340 days from the previous parturition. Meanwhile, the artificial insemination needs to match the time of estrus of the dairy cow which is a period of about 21 days. Accordingly, during the period of artificial insemination, coordination is necessary between the precise detection of the time of estrus of the dairy cow and the insemination by a copulation staff.

A technique to manage the time of estrus of farm animals is disclosed in Japanese Patent No. 3634308, Japanese Patent Kokai No. H10-160819, and Japanese Patent Kokai No. 2005-39349. Specifically, Japanese Patent No. 3634308 discloses a technique to attach an IC (Integrated Circuit) tag to each dairy cow in a barn, detect the time of estrus from a travel distance of the cow measured by the IC tag, and inform a worker of the time of estrus via a mobile terminal. Japanese Patent Kokai No. H10-160819 discloses a technique to determine the location of the farm animal in the pasture by using a GPS (Global Positioning System). As related technology, Japanese Patent Kokai No. 2005-39349 discloses a technique to manage, in an integrative manner, automatic instruments installed in a building.

However, relying only on the travel distance as activity information of the dairy cow for detecting the time of estrus may mislead the determination of the time of estrus. Further, this approach may not be able to distinguish symptoms of disease from the time of estrus. On the other hand, there exists a need for a technique which increases productivity of the dairy business by accurately identifying a cow in estrus and accurately determining the location of such cow, thereby permitting an effective coordination with a dairy worker or a copulation staff.

### SUMMARY OF THE INVENTION

An object of the present invention is to provide a breeding support system for the dairy industries which makes it possible to effectively carry out breeding work for an individual breeding object such as a farm animal.

A breeding support system of present invention includes at least one information terminal for processing breeding information associated with breeding work of at least one individual breeding object. The system comprises individual information collecting means for collecting individual information indicating a time-variable change of an individual condition of the individual breeding object; specified breeding work requirement determination means for determining a requirement for a specified breeding work from among all breeding work in accordance with a profile of the time-variable change of the individual condition; breeding guidance generation means for generating at least one breeding guidance announcing a requirement of the specified breeding work determined; and breeding guidance supply means for supplying the generated breeding guidance as the breeding information to the information terminal.

The breeding support system of the present invention provides a system to send notification for breeding guidance to a terminal such as a portable terminal. The breeding guidance expedites an appropriate work such as an artificial insemination in accordance with physical data and physiological data of an individual dairy animal such as a dairy cow. Accordingly, breeding work for an individual breeding object can be effectively carried out.

### BRIEF DESCRIPTION OF THE DRAWINGS

FIG. 1 is a block diagram showing an overall configuration of a first embodiment of the present invention including a breeding support system,

FIG. 2 is block diagram showing a detailed configuration a common management server shown in FIG. 1,

FIG. 3 is a diagram showing an example of a database stored in an individual information storing section shown in FIG. 2,

FIG. 4 is a diagram showing an example of a database stored in a guidance storing section shown in FIG. 2,

FIG. 5 is a sequence diagram showing a processing procedure to perform a health management including detection of the time of estrus of a dairy cow,

FIG. 6 is a block diagram showing an overall configuration of a second embodiment of the present invention including a breeding support system,

FIG. 7 is a flow diagram showing a processing procedure of the second embodiment, and

FIG. 8 is a diagram illustrating a manner to control a notification order of a breeding guidance in accordance with movement of the farm animal.

### DETAILED DESCRIPTION OF THE INVENTION

Embodiments of the present invention will be hereinafter described in detail with reference to the accompanying drawings.

### First Embodiment

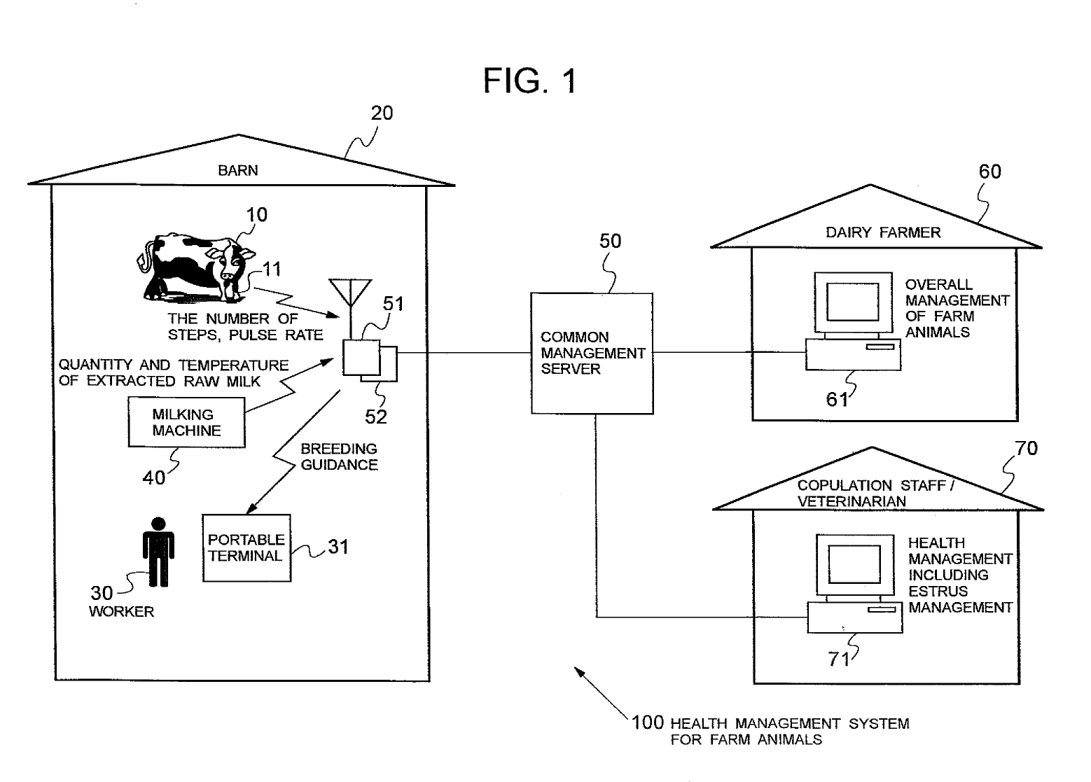

Referring to FIG. 1, a breeding support system 100 includes a barn 20, a facility 60 for a dairy farmer, a facility 70 for a copulation staff or a veterinarian, which are all connected with a network having a common management server 50 at its center. In the facility 60, there is provided a management terminal 61 such as a personal computer which is used by the dairy farmer for overall management of farm animals. In the facility 70, there is provided a management terminal 71 such as a personal computer which is used by a copulation staff or a veterinarian for health management including estrus management of the farm animals. The management terminals 61 and 71 serve as information terminals for processing breeding information associated with breeding work of an individual breeding object such as a dairy cow. The management terminals 61 and 71 have functions to output individual information and breeding guidance which are supplied from the common management server 50.

At least one dairy cow 10 is bred in the barn 20. A pedometer sensor 11 is attached to the dairy cow 10. The pedometer sensor 11 measures the number of steps of the dairy cow 10, which is combined with identification information of the dairy cow 10 and transmitted to the common management server 50 as individual information via a repeater 51. The pedometer sensor 11 may further measure a pulse rate of the dairy cow 10, which is combined with the identification information of the dairy cow 10 and transmitted to the common management server 50 as individual information.

The barn 20 is provided with a milker or a milking machine 40. The milking machine 40 extracts milk from the dairy cow 10 by a manual operation of a worker 30 or by an automatic operation. Quantity and temperature of the extracted raw milk are automatically measured as individual information, which are combined with the identification information of the dairy cow 10 and transmitted to the common management server 50 via a repeater 51.

The dairy worker 30 carries a portable terminal 31 which is a wireless terminal for data processing. A breeding guidance providing operating instructions is transmitted from the common management server 50 to the portable terminal 31 via the repeater 51. The breeding guidance means a massage expediting a specified breeding work which includes copulation to an individual breeding object such as a dairy cow or letting the veterinarian examine an individual breeding object.

The portable terminal 31 serves as an information terminal which processes breeding information associated with the breeding work of an individual breeding object. The portable terminal 31 has functions to output the breeding guidance supplied from the common management server 50 as an audio guidance or to display the breeding guidance on a liquid crystal panel. The breeding guidance may indicate, for example, not to mix milk extracted from an unhealthy farm animal with milk extracted from a healthy farm animal which is announced by, for example, audio. Based on this breeding guidance, the worker can judge whether to express milk or not. The breeding guidance may indicate other points to notice to the worker such as there being a farm animal with the drastically increased number of steps, there being a farm animal with an abnormally reduced amount of extracted milk, or there being a farm animal having an abnormally high temperature.

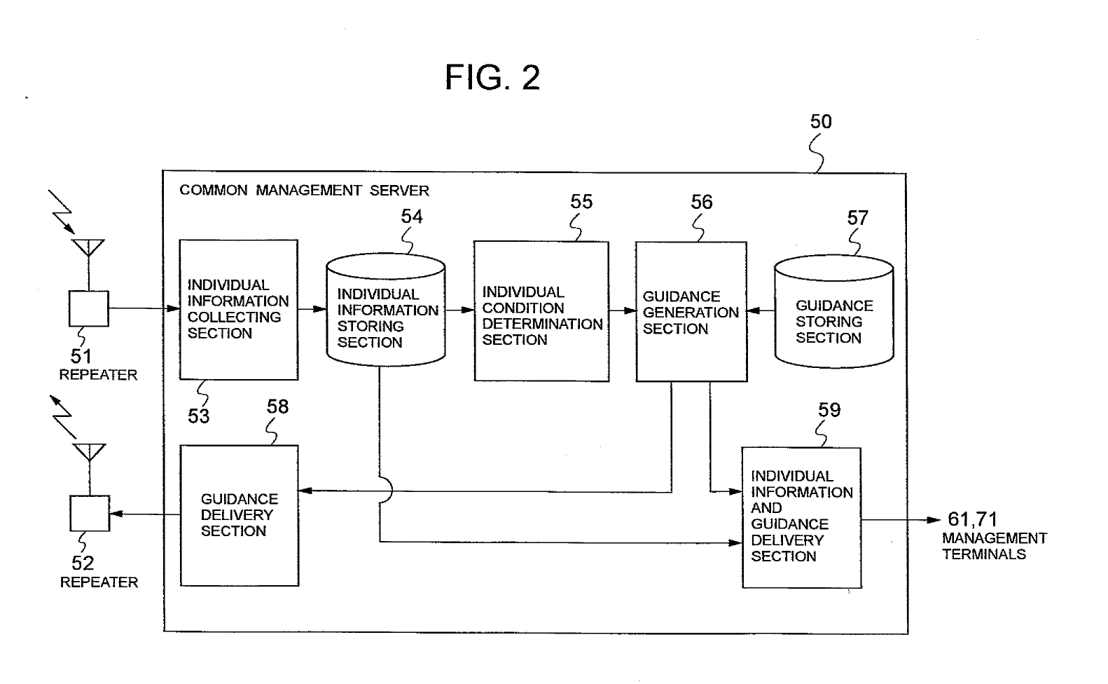

FIG. 2 shows a detailed configuration of the common management server shown in FIG. 1. The common management server 50 includes an individual information collecting section 53, an individual information storing section 54, an individual condition determination section 55, a guidance generation section 56, a guidance storing section 57, a guidance delivery section 58, and an individual information and guidance delivery section 59. The individual information collecting section 53 has functions to collect data such as the number of steps, pulse rate, and location of a dairy cow via the repeater 51, and storing these data into the individual information collecting section 54. The data of the number of steps, which is collected once every specified time period, represents the total number of steps accumulated within such specified time period. For example, assuming that the specified time period is one hour, the number of steps is collected once every one hour and thus the maximum 24 data of the number of steps are collected in one day. The location data, which is collected once every specified time period, represents a dairy-cow's average location, e.g., in the barn, in the specified time period. Such specified time period is preferably set to have the same period as that for collecting the data of the number of steps, i.e., one hour.

The individual condition determination section 55 has a function to determine individual conditions of each dairy cow in accordance with a time trend of the data stored in the individual information storing section 54. The individual conditions may include, for example, the number of steps, the amount of extracted milk, the temperature of raw milk, the location of the dairy cow, the expected time of the estrus, and the pulse rate. These individual conditions are rated into several ranks such as ‘very good’, ‘good’, ‘poor’ and ‘very poor’, based on certain criteria such as preferable threshold levels for these individual conditions. It should be noted that, although four ranks are described in this embodiment, these individual conditions may be rated into an alternative of either ‘good’ or ‘poor’.

The threshold level of the number of steps may be, for example, 1.5 to 1.6 times larger than the average number of steps of the normal dairy cows. The criteria are determined from an empirical rule that a dairy cow in estrus usually steps 1.5 to 1.6 times more than the normal dairy cows. In a similar manner, the appropriate threshold level of the pulse rate is determined from the empirical rule that the dairy cow in estrus usually has an increased pulse rate. It may be preferable to set a standard temperature of the raw milk at 38.0° C., and determine raw milk as ‘good’ when the temperature thereof falls within a range of ±0.5° C. from the standard temperature and determine raw milk as ‘poor’ when the temperature thereof is beyond such range.

The guidance generation section 56 has a function to generate a breeding guidance of each of the dairy cows based on the individual conditions determined by the individual condition determination section 55. The breeding guidance is produced in such a manner that an appropriate guidance is selected from a plurality of guidances stored in the guidance storing section 57 based on individual conditions of a dairy cow concerned, and then the selected guidance is combined with identification information of the dairy cow.

The individual information and guidance delivery section 59 has a function to deliver the individual information stored in the individual information storing section 54 and the breeding guidance generated by the guidance generation section 56 on an on demand basis to the management terminal 61 provided in the facility for the dairy farmer and the management terminal 71 provided in the facility for the copulation staff or veterinarian. The guidance delivery section 58 has a function to deliver the breeding guidance generated by the guidance generation section 56 to a mobile terminal carried by a worker via a repeater 52.

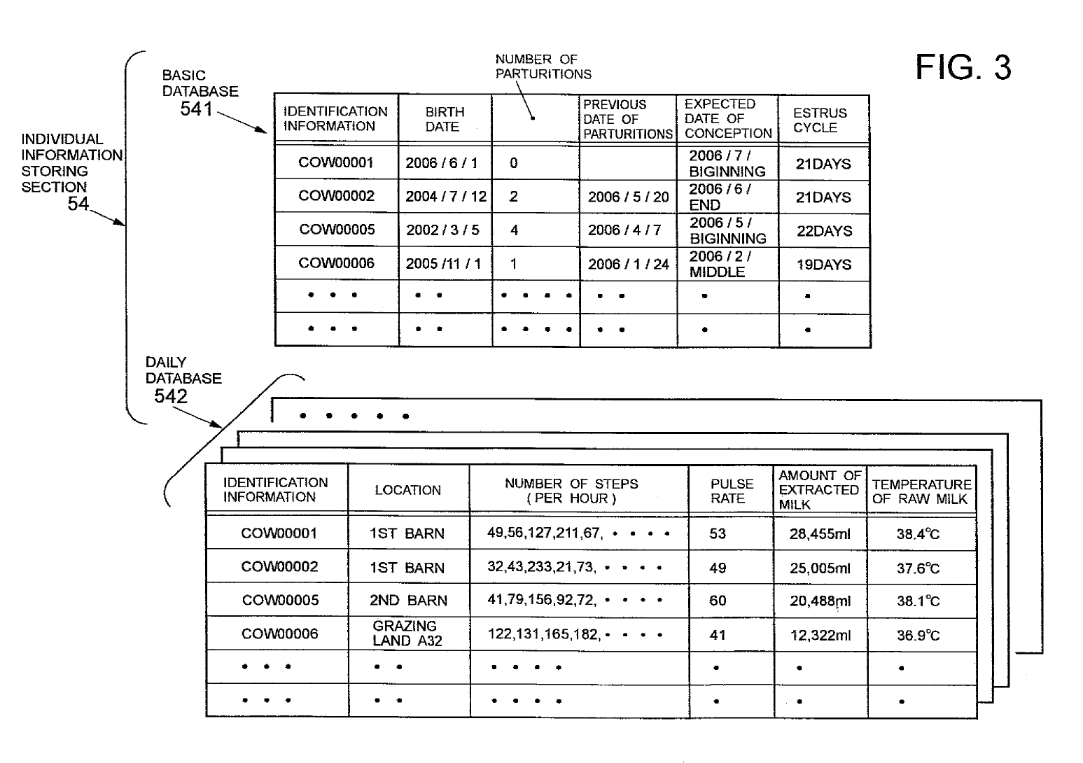

FIG. 3 shows an example of a database stored in the individual information storing section 54 of FIG. 2. The individual information storing section 54 includes, for example, basic database 541 and daily database 542. The basic database 541 includes, for example, identification information such as code number to identify a dairy cow, birth date, the number of parturitions, previous date of parturition, expected date of conception, and estrus cycle, which need to be input in advance. The daily database 542 includes data which are collected by the individual information collecting section 53 and are sequentially stored by the day. The daily database 542 includes daily data of each dairy cow such as, for example, location, the number of steps, pulse rate, the amount of extracted milk, and the temperature of raw milk.

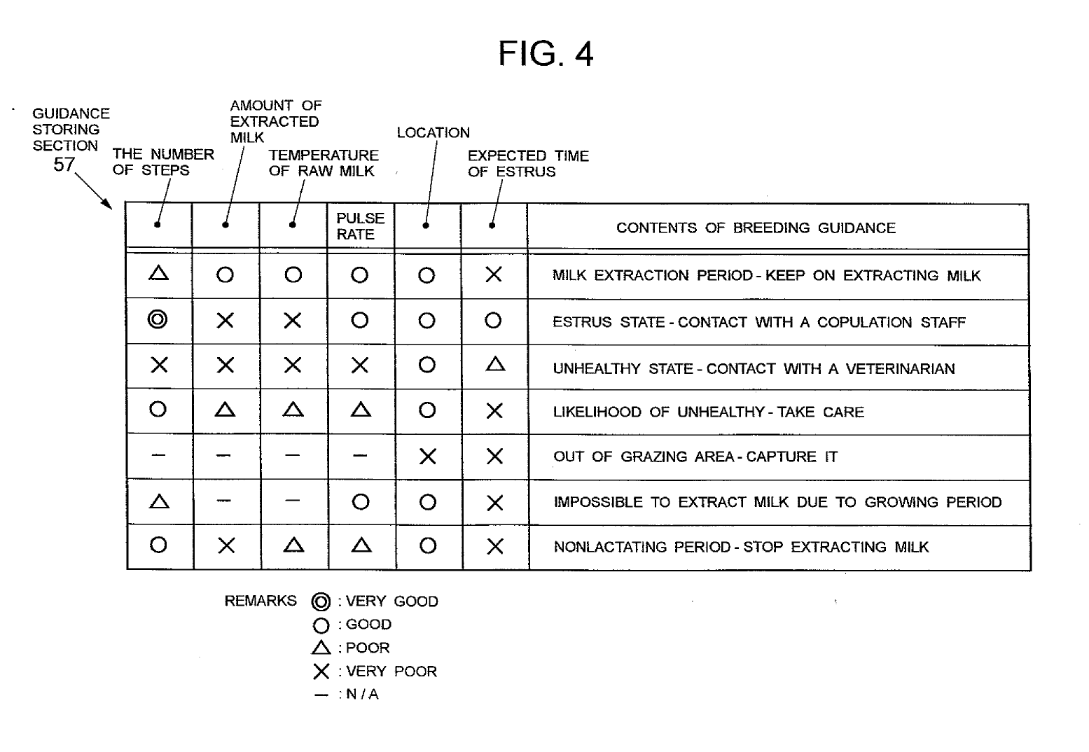

FIG. 4 shows an example of the database stored in the guidance storing section 57 of FIG. 2. The guidance storing section 57 stores guidance contents. Each of the guidance contents corresponds to a combination of the individual conditions with respective ranks. Specifically, each combination of the individual conditions includes, for example, the number of steps, the pulse rate, the amount of extracted milk, the temperature of raw milk, the location of the dairy cow, and the expected time of the estrus with respective ranks such that each combination of the individual conditions corresponds to a specific breeding guidance. It should be noted that these ranks of ‘very good’, ‘good’, ‘poor’ and ‘very poor’ are determined by the individual condition determination section 55 as described above. For example, a combination of very good at the number of steps, very good at the pulse rate, very poor at the amount of extracted milk, very poor at the temperature of raw milk, very good at the location of the dairy cow, and very good at the expected time of the estrus provides a guidance expressing ‘the dairy cow seems to be in a state of estrus, and therefore please contact with a copulation staff.’ When another combination of the individual conditions is newly detected, another content of the breeding guidance will be generated together with the identification information of the dairy cow.

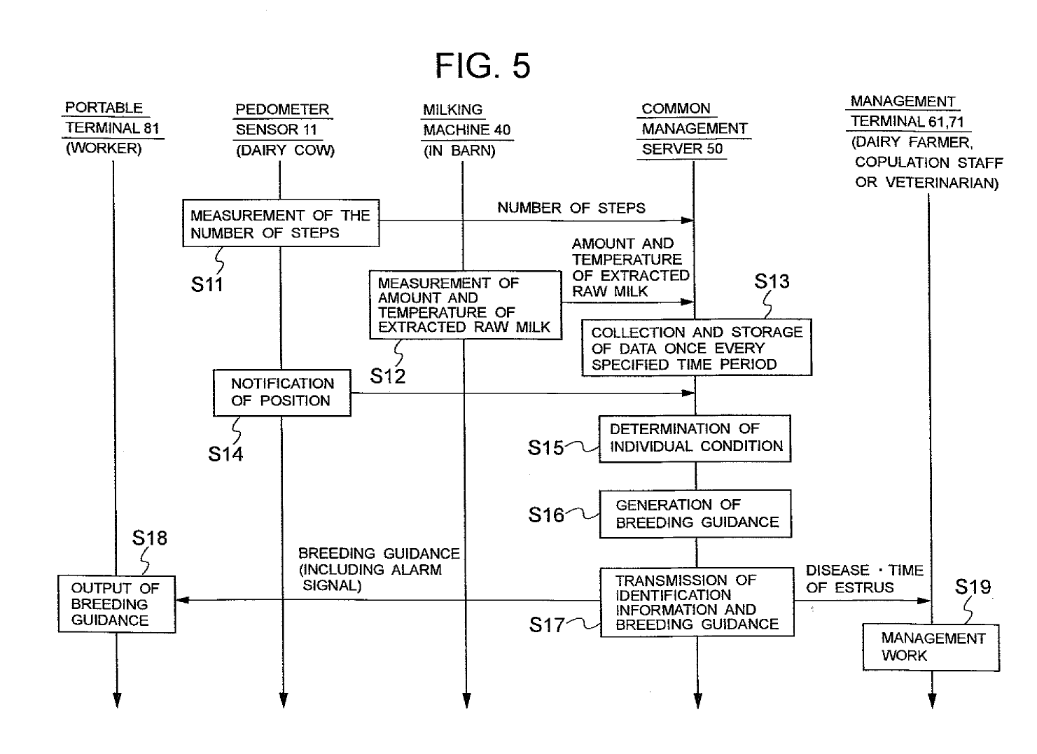

FIG. 5 shows a processing procedure to carry out health management of the dairy cow including detection of the estrus. In this instance, it is assumed that the dairy cow is bred in the barn shown in FIG. 1.

The pedometer sensor 11 measures the number of steps and the pulse rate of the dairy cow (step S11). The number of steps is then transmitted to the common management server 50 once every specified time intervals, for example, every one hour. On the other hand, the milking machine 40 measures the amount of extracted milk and the temperature of raw milk (step S12). Since milk is usually extracted once per day, these measured data of the amount of extracted milk and the temperature of raw milk are transmitted to the common management server 50 once per day together with the individual information.

The common management server 50 collects and stores these data of the number of steps, the amount of extracted milk of the dairy cow and the temperature of the raw milk once every specified time period (step S13). The pedometer sensor 11 also notifies the location of the dairy cow to the common management server 50 (step S14).

The common management server 50 then determines individual conditions of each of the dairy cows based on the collected data (step S15). The individual conditions include, for example, the number of steps, the amount of extracted milk, the temperature of raw milk, the location of the dairy cow, the expected time of the estrus, and the pulse rate. The common management server 50 then generates a breeding guidance of each of the dairy cows based on the determined individual conditions (step S16). A guidance corresponding to the individual conditions of a dairy cow concerned is selected from a plurality of guidance contents stored in the guidance storing section 57. The selected guidance is combined with identification information of the dairy cow so that a breeding guidance is generated.

The common management server 50 then transmits the generated breeding guidance to a portable terminal 31 carried by a worker or management terminals 61, 71 for a dairy farmer, copulation staff or veterinarian (step S17). Accordingly, the portable terminal 31 outputs the breeding guidance via, for example, its display (step S18). The breeding guidance includes an alarm signal for notifying estrus or disease. Since a worker in a dairy site is notified of such breeding guidance in an easy-to-understand manner by means of, for example, an audio guidance, overlook of the time of estrus can be remarkably reduced. In addition, accidents such as contamination of milk from a healthy cow with milk from an unhealthy cow can be prevented.

On the other hand, the management terminal 61 or 71 similarly output the breeding guidance, which is used for management (step S19). The management terminal may receive individual information such as the number of steps, pulse rate, and the amount of extracted milk together with the breeding guidance. Accordingly, appropriate product management by the dairy farmer, appropriate copulation in prompt response to the time of estrus by the copulation staff, and appropriate health management such as treatment for disease by the veterinarian can be performed.

Application of the breeding support system according to the first embodiment of the present invention makes it possible to effectively manage an individual breeding object such as a dairy cow and improve the productivity of the dairy business. This system simultaneously collects physical data such as the number of steps of a moving object such as a dairy cow and physiological data such as the amount of extracted milk and the temperature of raw milk. Based on these data, the system generates an appropriate breeding guidance such as notifying the time of estrus. The breeding guidance is sent to terminals used by a worker, a dairy farmer, a copulation staff, or a veterinarian engaged in a dairy business. Such breeding guidance is generated in response to change of the individual conditions, and therefore efficient operation such as copulation within 8 hours from the time of estrus can be carried out without overlooking the time of estrus or diseases.

### Second Embodiment

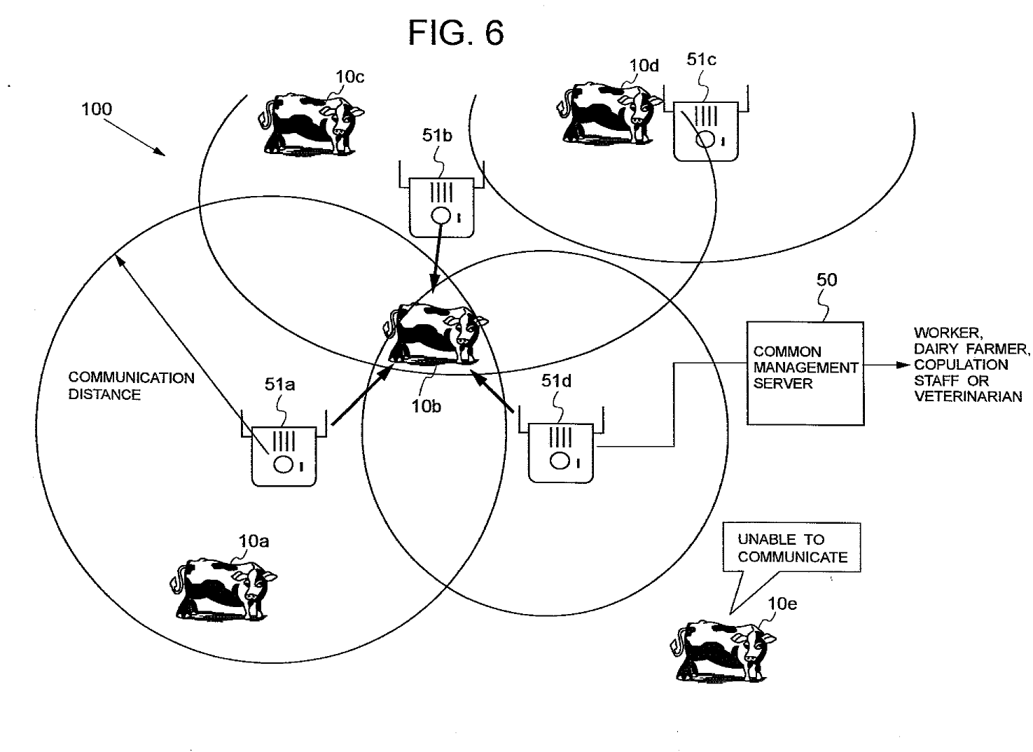

FIG. 6 shows a second embodiment of the present invention in which an overall configuration including a breeding support system is shown. In this embodiment, the breeding support system obtains individual information including the number of steps and location of a dairy cow located in a vast cattle pasture outside the barn.

The breeding support system 100 includes a common management server 50 which is similar to that of the first embodiment. The common management server 50 is connected with a plurality of repeaters 51a-51d, a management terminal for a dairy farmer, copulation staff or veterinarian, and portable terminal for a worker. Each of the repeaters 51a-51d wirelessly collects data of the number of steps transmitted from pedometer sensors (not shown) respectively attached to a plurality of dairy cows 10a-10d.

Wireless communication means configured by the combination of the repeaters 51a-51d and the pedometer sensors may, for example, use transmission method called ZigBee (registered trademark). It should be noted that the ZigBee method has a feature to function as a repeating installation that can simultaneously transfer a plurality of individual data. The ZigBee method also has a feature to function as a repeating installation that can achieve a multi-hop communication, thereby making it possible to widely send and receive the data even though a communication distance is rather short, i.e., approximately 30 m. The ZigBee method has another advantage of low electric power consumption which allows distributing a number of wireless communication means to cover a wide area.

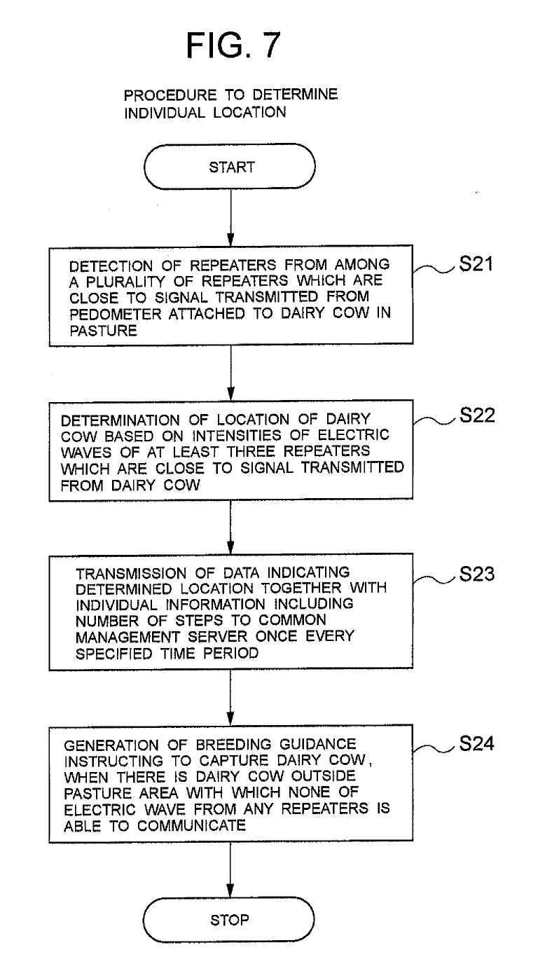

FIG. 7 shows a processing procedure to determine an individual location performed in the second embodiment. This processing procedure is carried out in collaboration with a plurality of repeaters 51a-51d shown in FIG. 6. Therefore, the processing procedure will be mainly described about a group of repeaters including a plurality of repeaters 51a-51d.

The group of repeaters firstly detects some repeaters among the plurality of repeaters which are close to a signal transmitted from a pedometer attached to a dairy cow in the pasture (step S21). Location of the dairy cow is then determined based on the intensities of electric waves of at least three repeaters which are close to the signal transmitted from the pedometer attached to the dairy cow (step S22). It should be noted that increased number of the repeaters may improve the accuracy of the location of the dairy cow.

The group of the repeaters then transmits data indicating the determined location together with the individual information including the number of steps to the common management server once every specified time period (step S23).

On the other hand, when there is a dairy cow outside the pasture area where none of the electric wave from any repeaters is able to reach, the common management server 50 generates a breeding guidance instructing to capture such dairy cow (step S24). The breeding guidance is sent to a worker from the common management server 50 via a portable terminal.

It should be noted that standard for achieving the above described wireless communication means is not limited to ZigBee, and other wireless standards may be used such as PHS (Personal Handyphone System), cellular telephone, wireless LAN, Bluetooth (registered trademark), and specified low power radio.

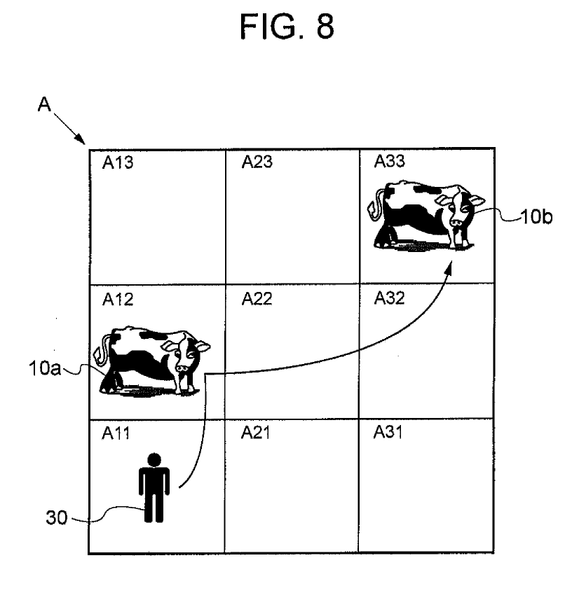

FIG. 8 illustrates a manner to control a notification order of the breeding guidance after migration of farm animals. In this figure, it is assumed for the sake of simplicity that two dairy cows 10a and 10b are both located within a squared area A, and that they are respectively located within any of nine small squares A11-A33 after migration. Actual shapes of the small squares A11-A33 may vary depending on the location of the repeaters.

It is now assumed that the dairy cows 10a and 10b are both in the state of estrus or unhealthy condition at the same time. In this case, the individual information of the dairy cows 10a and 10b are transferred to the common management server. The breeding guidance of each of the dairy cows 10a and 10b according to the individual information is then sent to a portable terminal carried by a worker. In this instance, based on the location of the portable terminal carried by the worker 30, notification of the breeding guidance of the dairy cow 10a located closest to the worker 30 is given a high priority, whereas notification of the breeding guidance of the dairy cow 10b located second closest to the worker 30 is given a low priority. The worker 30 thus follows an area instruction with the breeding guidance shown on the display. Specifically, the worker 30 firstly moves to the small square A11 to take care of the dairy cow 10a, and then moves to the small square A33 to take care of the dairy cow 10b. The control of the notification order of the breeding guidances can thus effectively support the breeding work of the worker. For example, when a plurality of dairy cows are in estrus, the breeding guidances are displayed sequentially in ascending order of distance between a dairy cow and the current location of the worker. Accordingly, the worker can work efficiently. Further, when a dairy cow is outside an area where no electric wave is able to reach, the worker can receive notification of a breeding guidance which instructs to capture such dairy cow. This accident occurs when, for example, a dairy cow runs away from a grazing district. The breeding guidance in this case may include information of a last place where such dairy cow was located.

With the arrangement shown in the second embodiment, individual data of the number of steps can be collected together with the location data not only from a dairy cow in a narrow space such as a barn shown in the first embodiment but also from a dairy cow in a large space such as a grazing area. By using the wireless communication means such as ZigBee, the individual information can be collected from a large space such as a grazing area at a low cost.

Although the embodiments of the breeding support system according to the present invention have been described based on the individual breeding objects being farm animals such as dairy cows or sheep, the individual breeding objects are not limited thereto. The individual breeding objects may be other animals such as pet animals kept at home.

This application is based on a Japanese patent application No. 2006-337063 which is herein incorporated by reference.

What is claimed is:

1. A breeding support system including at least one information terminal for processing breeding information associated with breeding work of at least one individual breeding object, the system comprising:
individual information collecting means for collecting individual information indicating a time-variable change of an individual condition of the individual breeding object;
specified breeding work requirement determination means for determining a requirement for a specified breeding work from among all breeding work in accordance with a profile of the time-variable change of the individual condition;
breeding guidance generation means for generating at least one breeding guidance announcing a requirement of the specified breeding work determined; and
breeding guidance supply means for supplying the generated breeding guidance as the breeding information to the information terminal.

2. The support system according to claim 1, wherein the individual information collecting means collects at least one of physical data indicating time-variable change of a physical condition of the individual breeding object and physiological data indicating time-variable change of a physiological condition of the individual breeding object as the individual information.

3. The support system according to claim 2, wherein the individual information collecting means collects at least one data of the number of steps and location of the breeding object as the physical data.

4. The support system according to claim 2, wherein the individual information collecting means collects at least one data of pulse rate, an amount of extracted milk, and temperature of raw milk as the physiological data.

5. The support system according to claim 1, wherein the individual information collecting means includes wireless communication means for collecting the individual information by use of a wireless communication method.

6. The support system according to claim 1, wherein the individual information collecting means includes wireless communication means for collecting the individual information by use of a wireless communication method in accordance with the ZigBee standard.

7. The support system according to claim 1, wherein the specified breeding work requirement determination means determines a requirement for a copulation work as a specified breeding work.

8. The support system according to claim 1, wherein the specified breeding work requirement determination means determines a requirement for treatment of disease as a specified breeding work.

9. The support system according to claim 1, wherein the specified breeding work requirement determination means determines a requirement to capture an individual breeding object that is outside a specified area as a specified breeding work.

10. The support system according to claim 1, wherein the specified breeding work requirement determination means determines a requirement to stop expressing milk as a specified breeding work.

11. The support system according to claim 1, wherein the at least one individual breeding object is a plurality of individual breeding objects, and the breeding guidance supply means further includes control means for controlling a display order of a plurality of breeding guidances on the information terminal in accordance with current locations of the plurality of individual breeding objects.

12. The support system according to claim 1, wherein the individual information collecting means, the specified breeding work requirement determination means, the breeding guidance generation means, and the breeding guidance supply means are included in a management server connected with a network system.

13. The support system according to claim 1, wherein the individual information is transmitted to the individual information collecting means via at least one repeater.

14. The support system according to claim 1, wherein the individual information is transmitted from a sensor attached to the individual breeding object.

15. The support system according to claim 1, wherein the breeding guidance is transmitted to the information terminal via a repeater.

16. The support system according to claim 15, wherein the information terminal is a portable terminal.

17. The support system according to claim 16, wherein the at least one individual breeding object is a plurality of individual breeding objects, and the breeding guidance supply means controls a display order of a plurality of breeding guidances on the information terminal in accordance with current locations of the plurality of individual breeding objects and current location of the information terminal.

18. A breeding support system including at least one information terminal for processing breeding information associated with breeding work of at least one individual breeding object, the system comprising:
an individual information collecting unit for collecting individual information indicating a time-variable change of an individual condition of the individual breeding object;
a specified breeding work requirement determination unit for determining a requirement for a specified breeding work from among all breeding work in accordance with a profile of the time-variable change of the individual condition;
a breeding guidance generation unit for generating at least one breeding guidance announcing a requirement of the specified breeding work determined; and
a breeding guidance supply unit for supplying the generated breeding guidance as the breeding information to the information terminal.
